(19) United States
(12) Patent Application Publication
(10) Pub. No.: US 2014/0032242 A1
(43) Pub. Date: Jan. 30, 2014

(54) CROSS-FACILITY CLOUD BASED PHYSICIAN PATIENT DATA MANAGEMENT AND REPORTING PLATFORM

(71) Applicants: David V. LaBorde, Tucker, GA (US); Jason G. Faulk, Dacula, GA (US)

(72) Inventors: David V. LaBorde, Tucker, GA (US); Jason G. Faulk, Dacula, GA (US)

(21) Appl. No.: 13/724,163

(22) Filed: Dec. 21, 2012

Related U.S. Application Data
(60) Provisional application No. 61/579,956, filed on Dec. 23, 2011.

(51) Int. Cl. G06F 19/00

(52) U.S. Cl. CPC G06F 19/322
USPC 705/3

(57) ABSTRACT

A web-browser accessible cloud based patient list manager for point of care capture, cloud based hosting, and subsequent viewing of structured data and reports about physician or other provider care episodes. Users capture the headlines of each care episode that will permit a focused set of value creation while the details reside in the electronic or paper based medical records systems. The repository of structured data resulting from the use creates a data asset of significant value. Several modular bolt on solutions leverage this structured data to help physician and other provider subscribers improve and facilitate the efficiency and safety of patient management, diagnostic imaging management, clinical work flows, charge capture, revenue cycle management, accreditation reporting, quality and outcomes monitoring and improvement, among other things. The invention improves the business and clinical intelligence of end users resulting in better financial performance, lower healthcare costs to payors, and better outcomes.

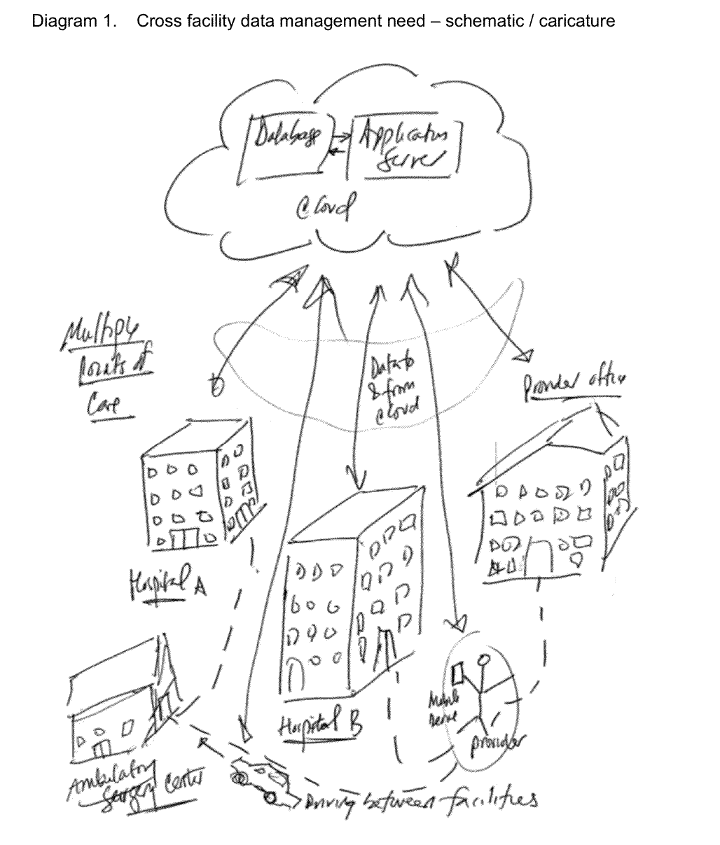

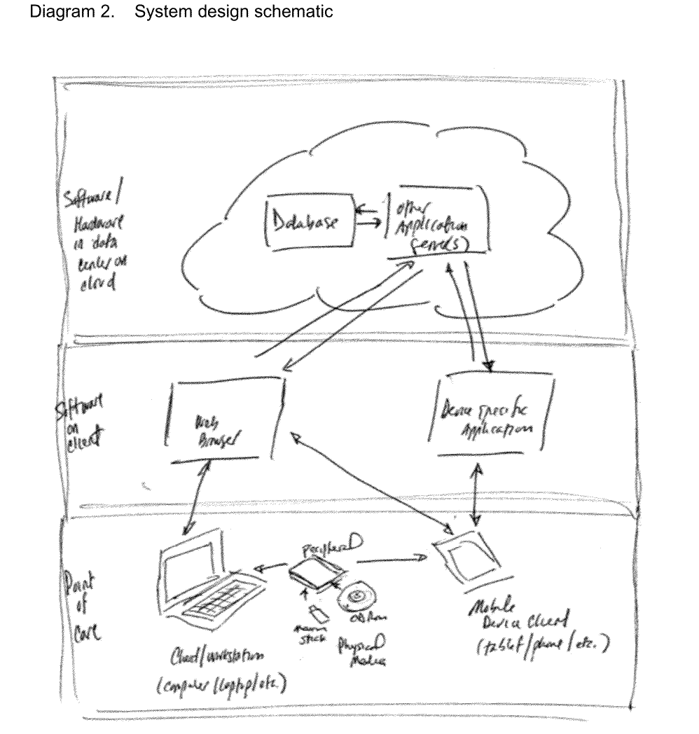

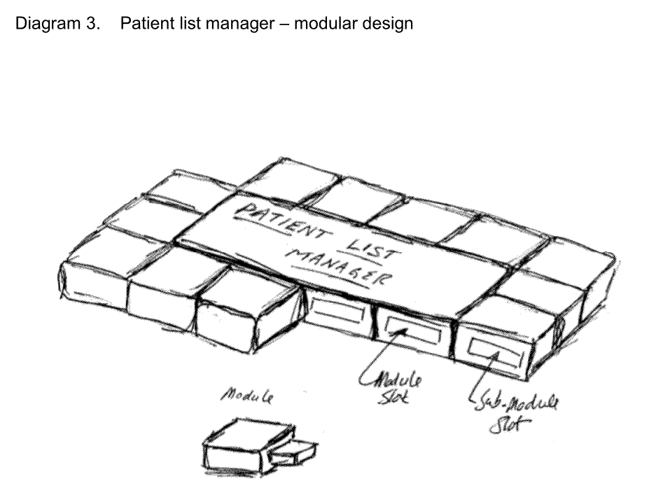

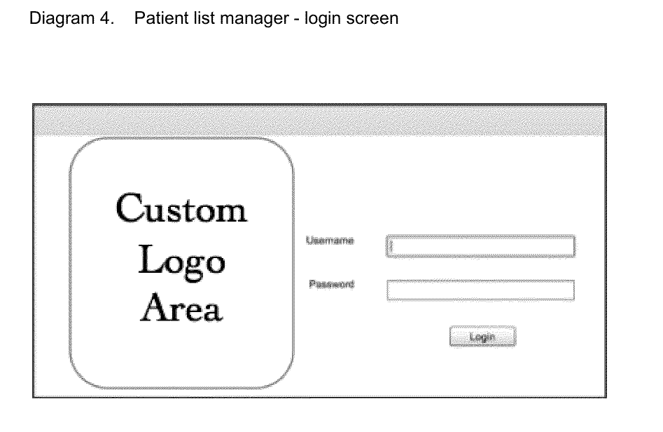

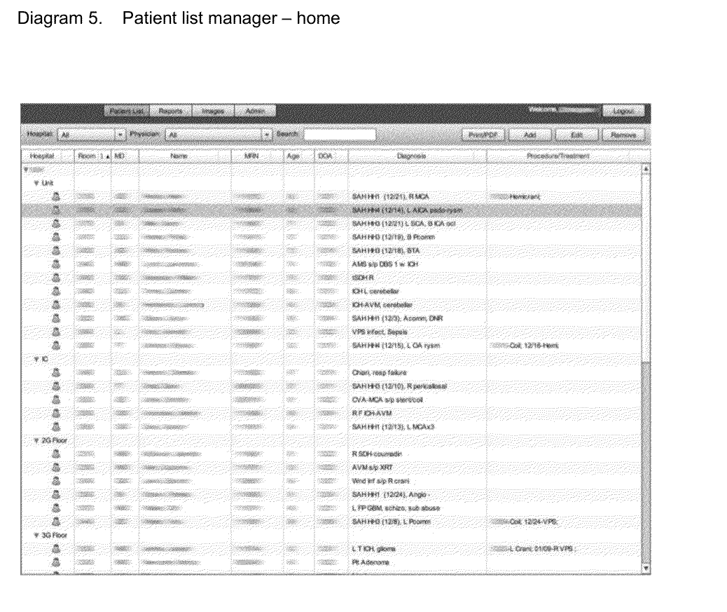

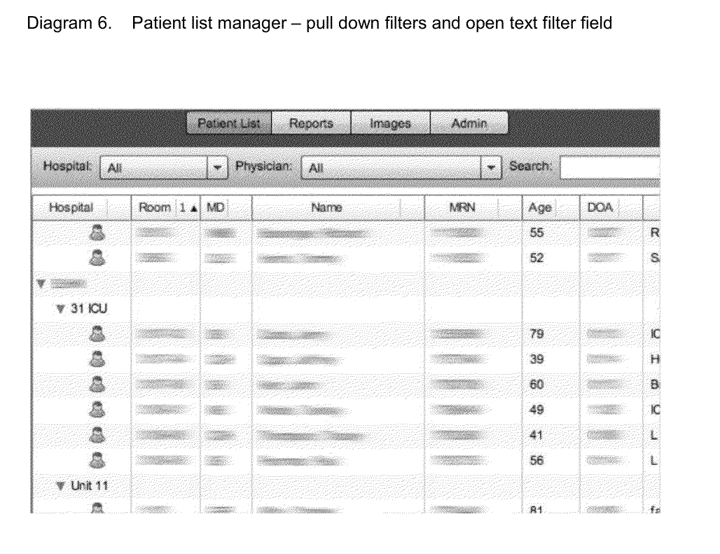

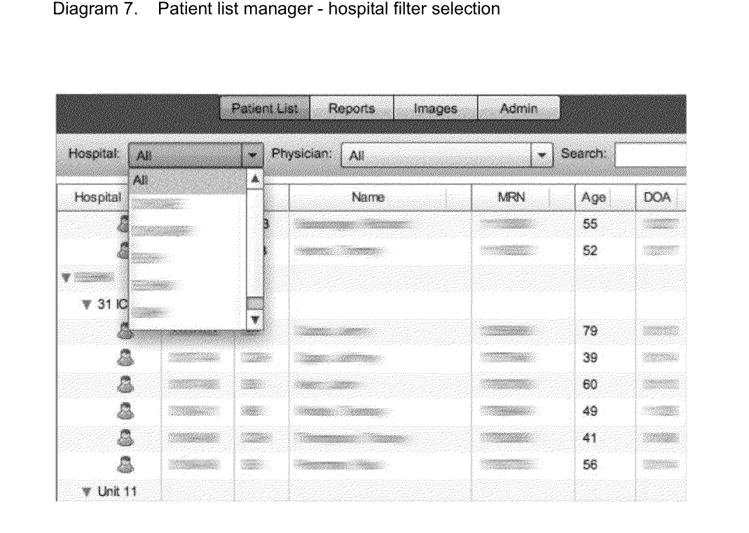

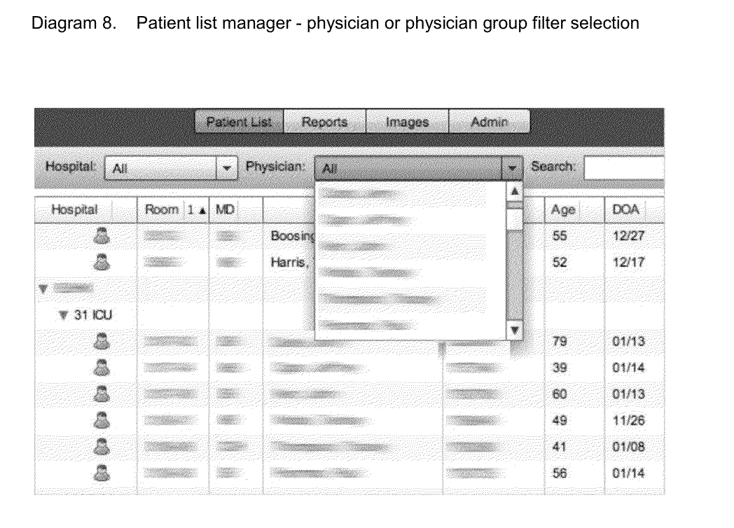

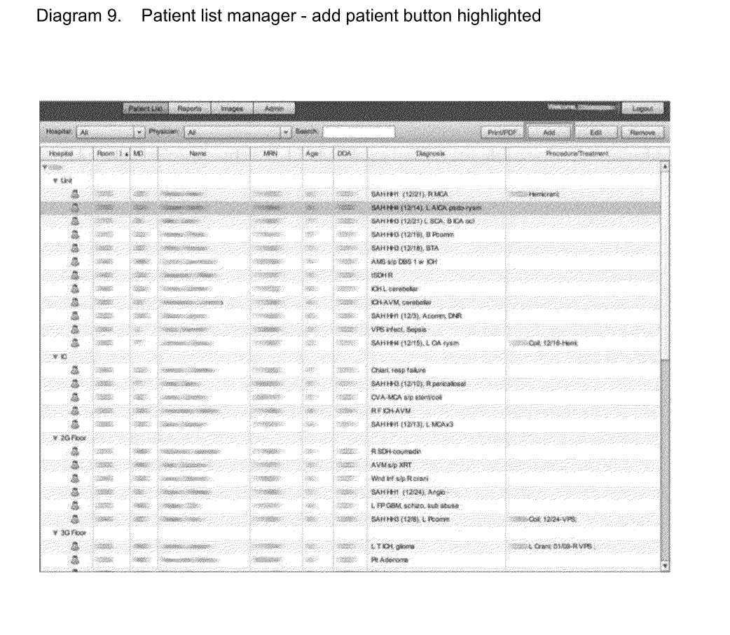

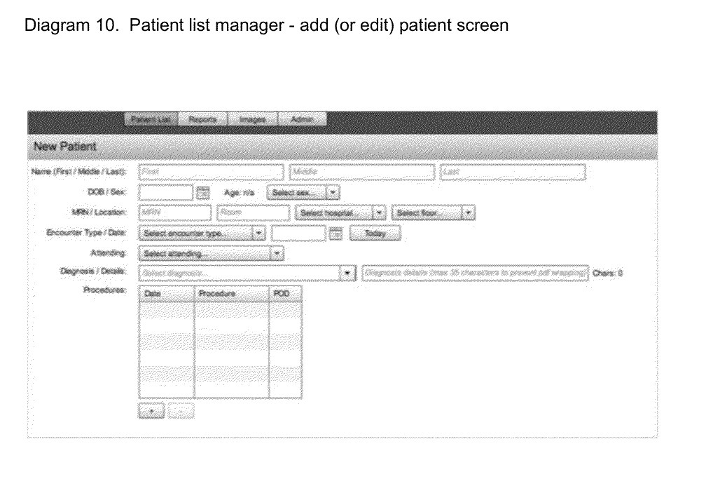

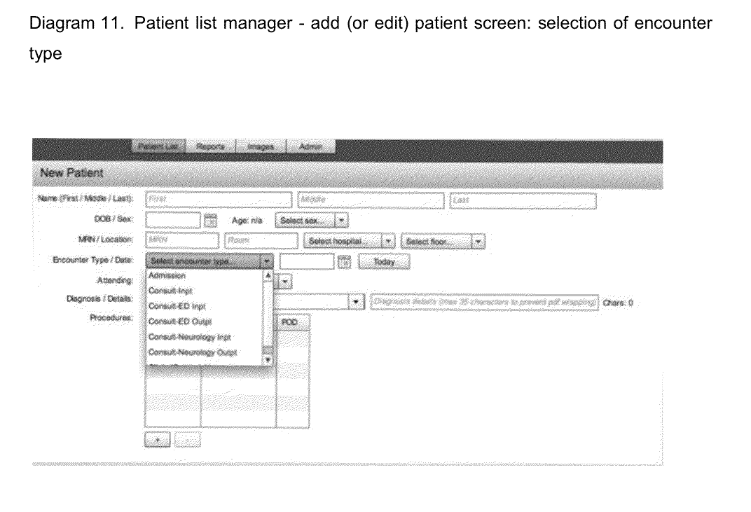

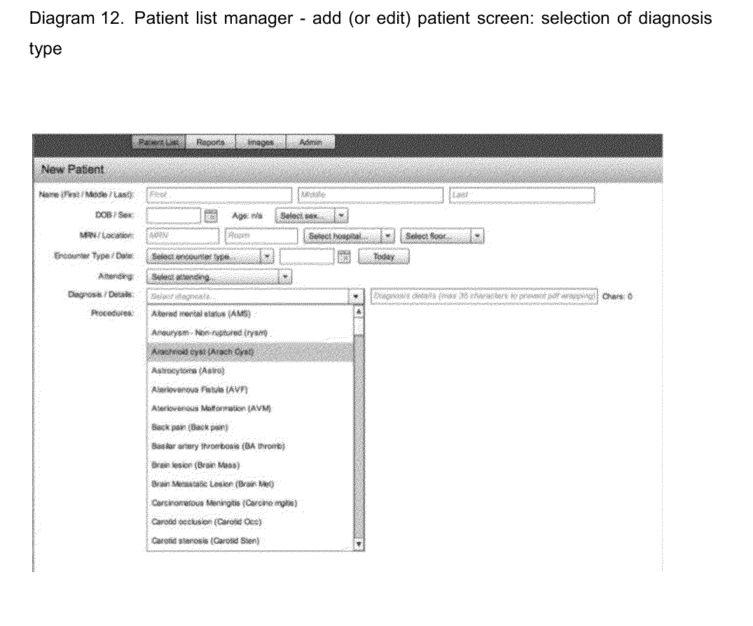

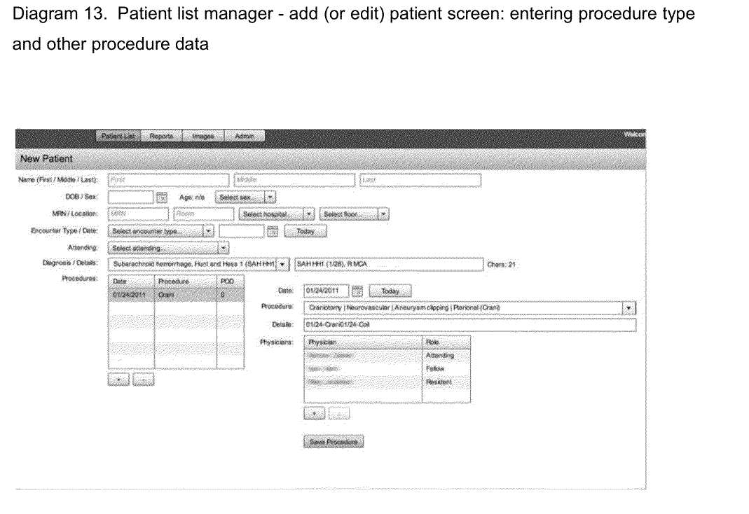

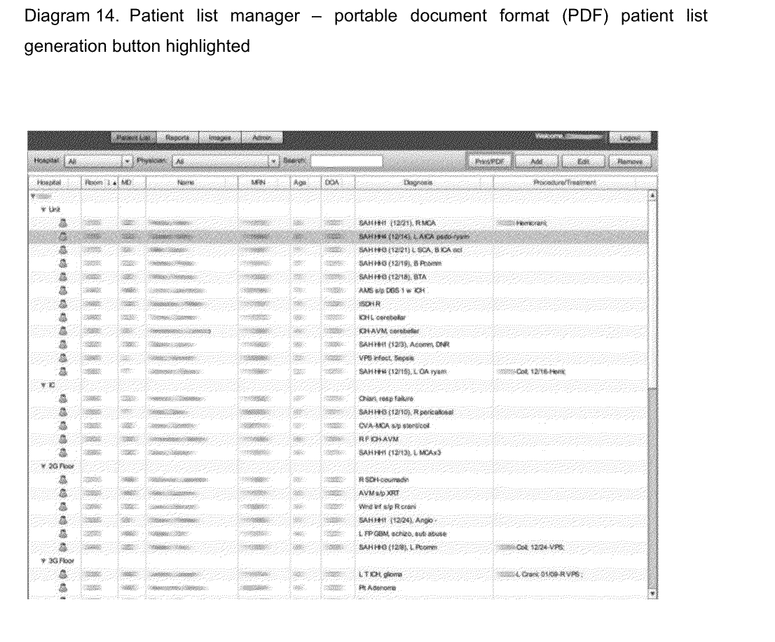

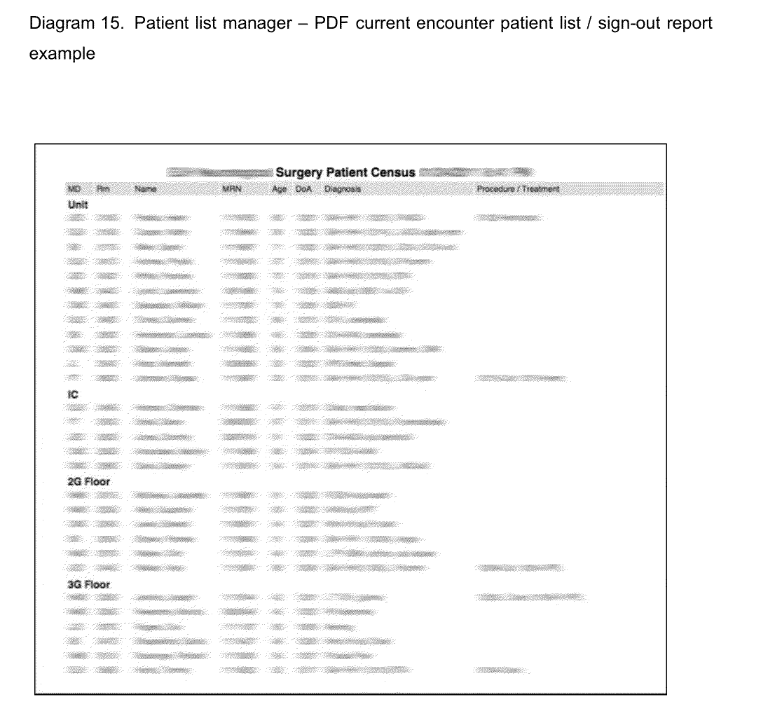

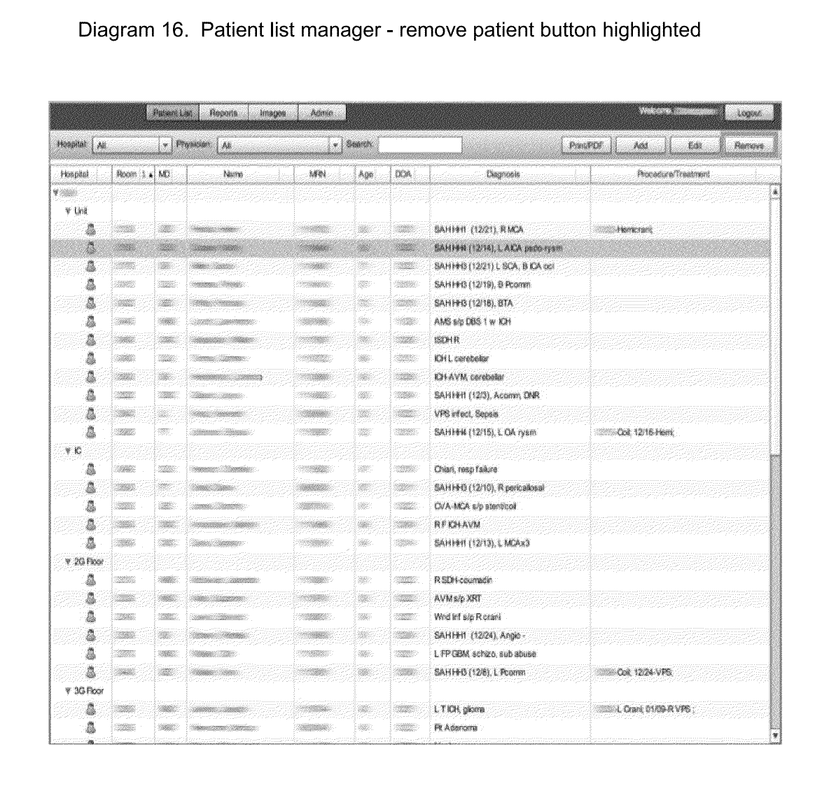

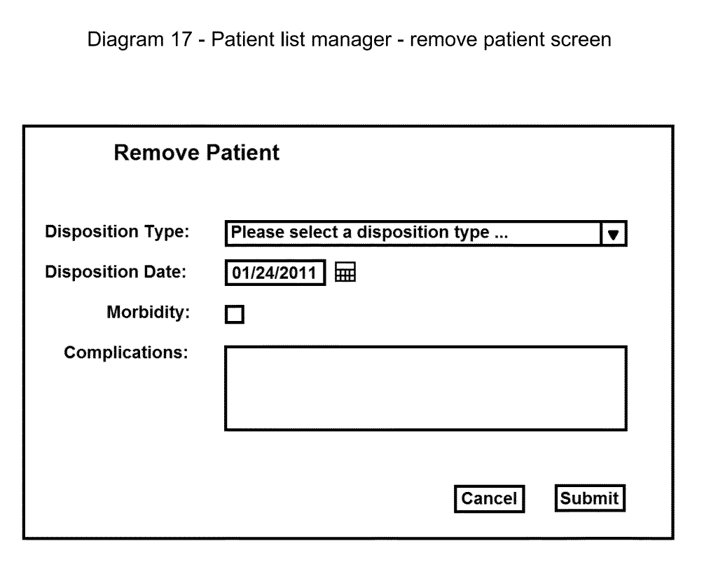

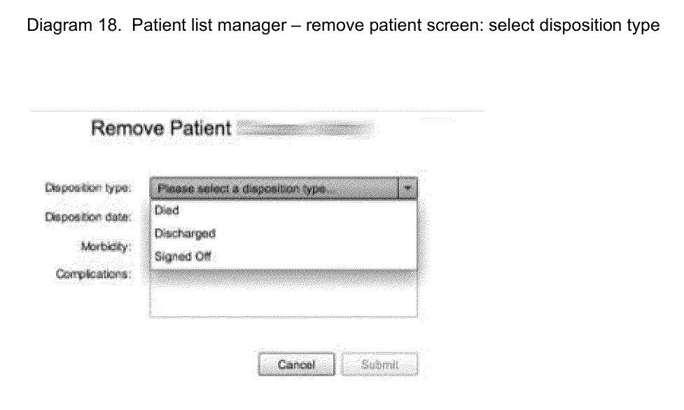

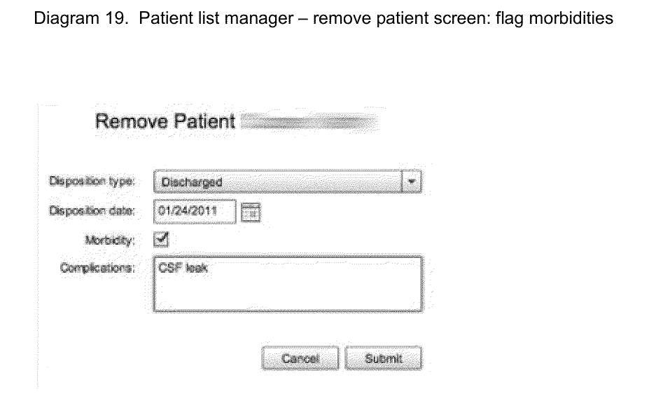

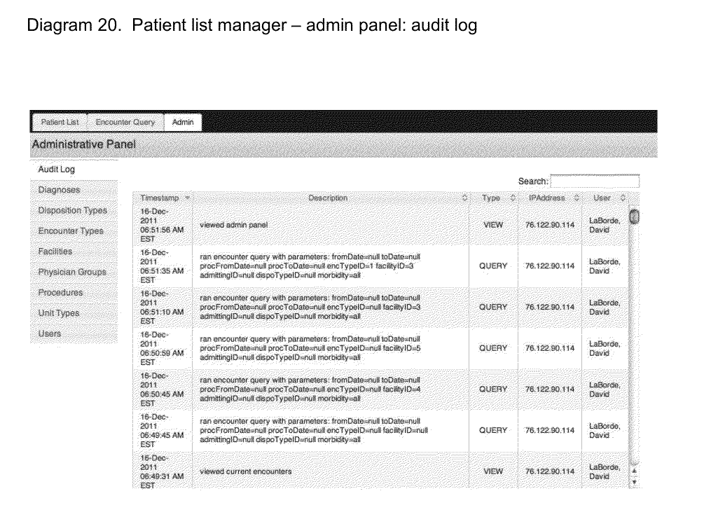

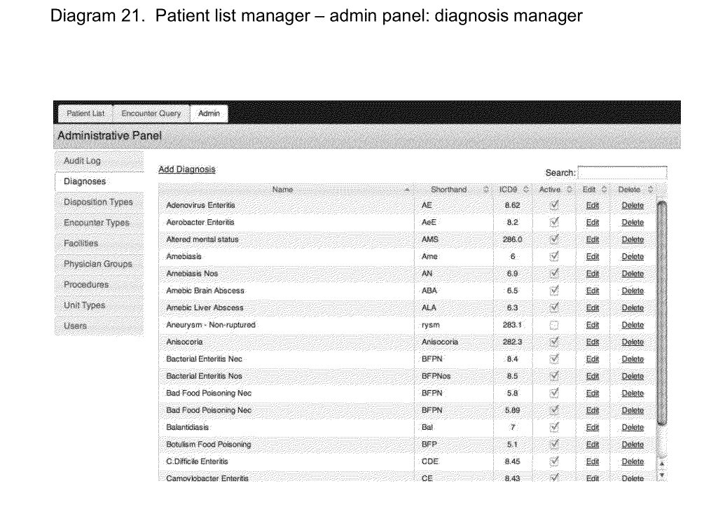

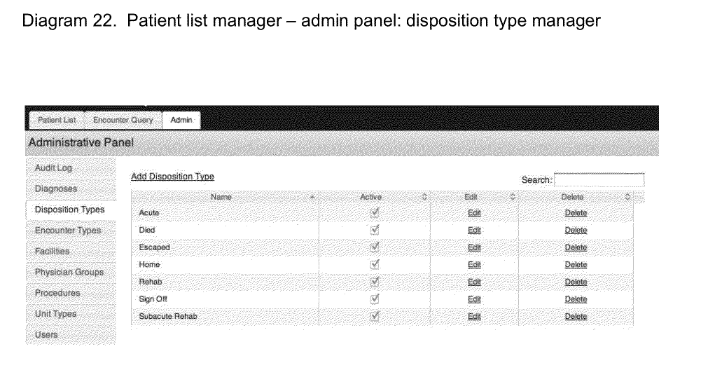

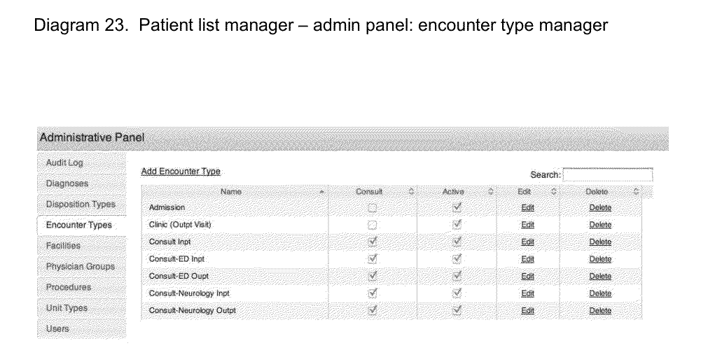

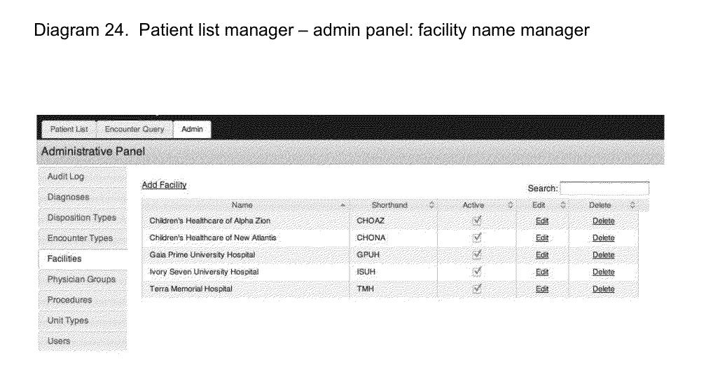

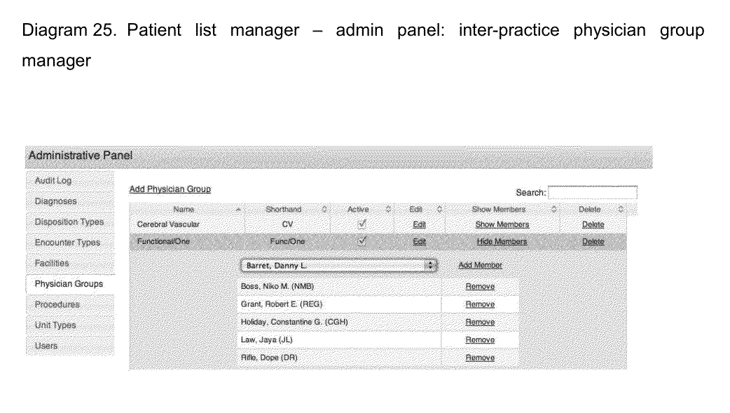

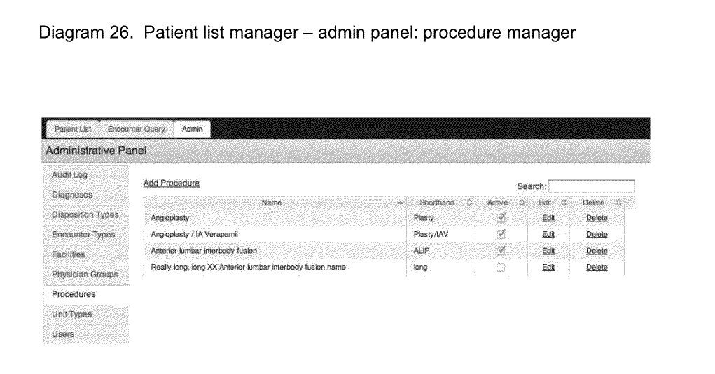

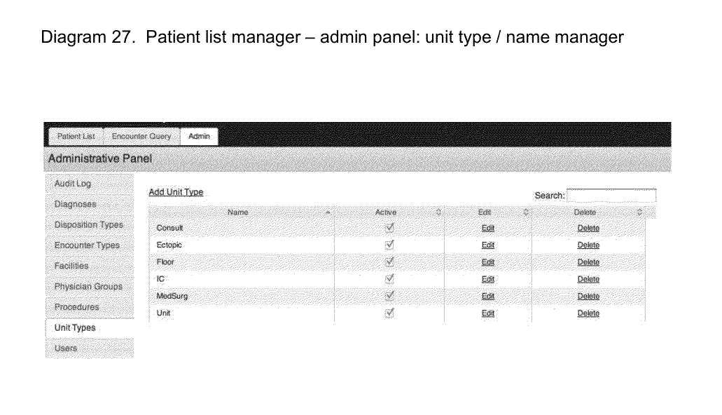

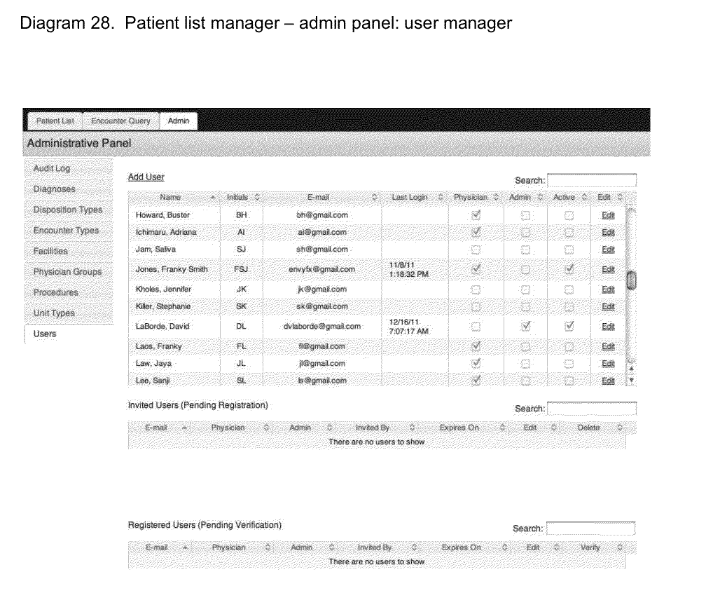

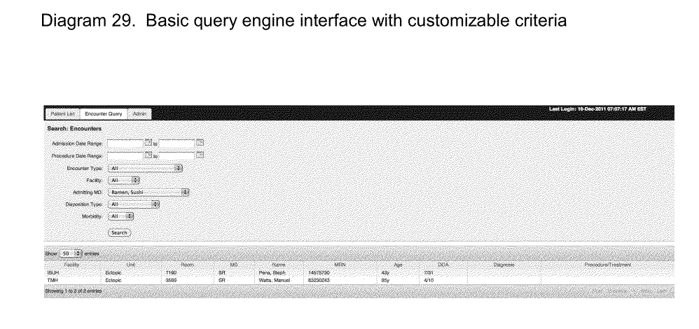

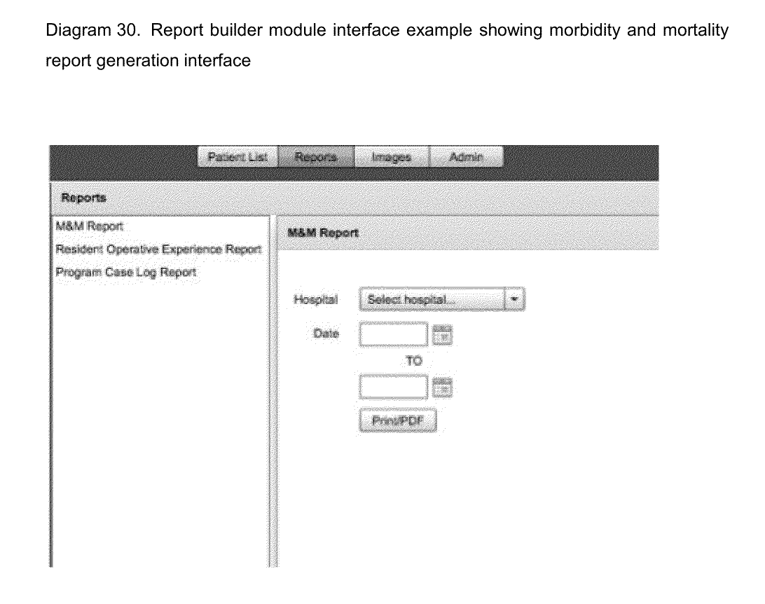

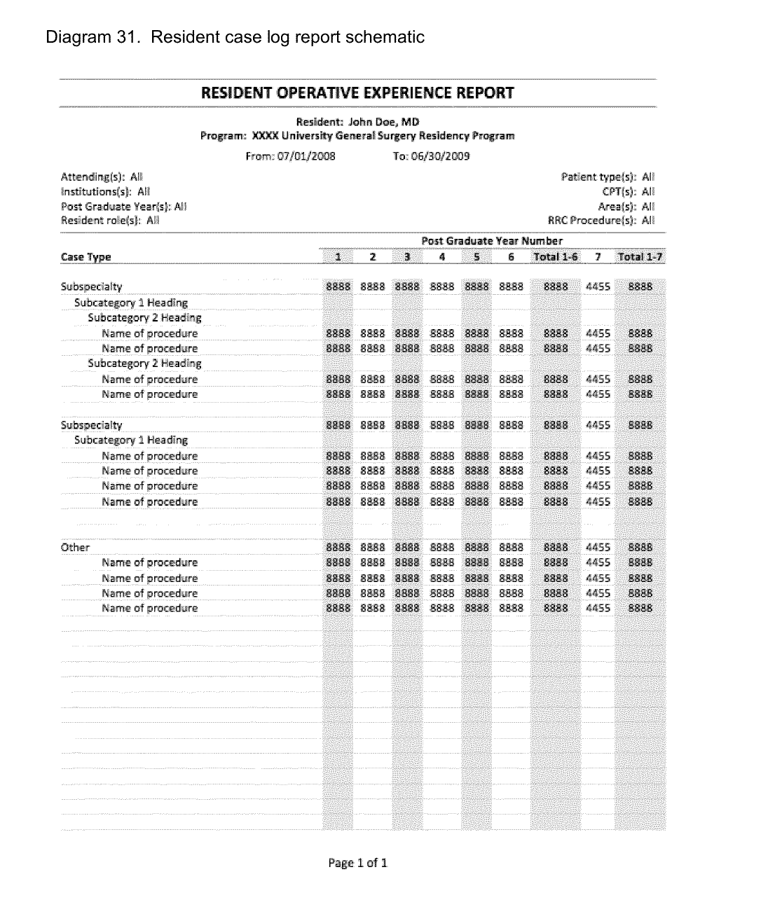

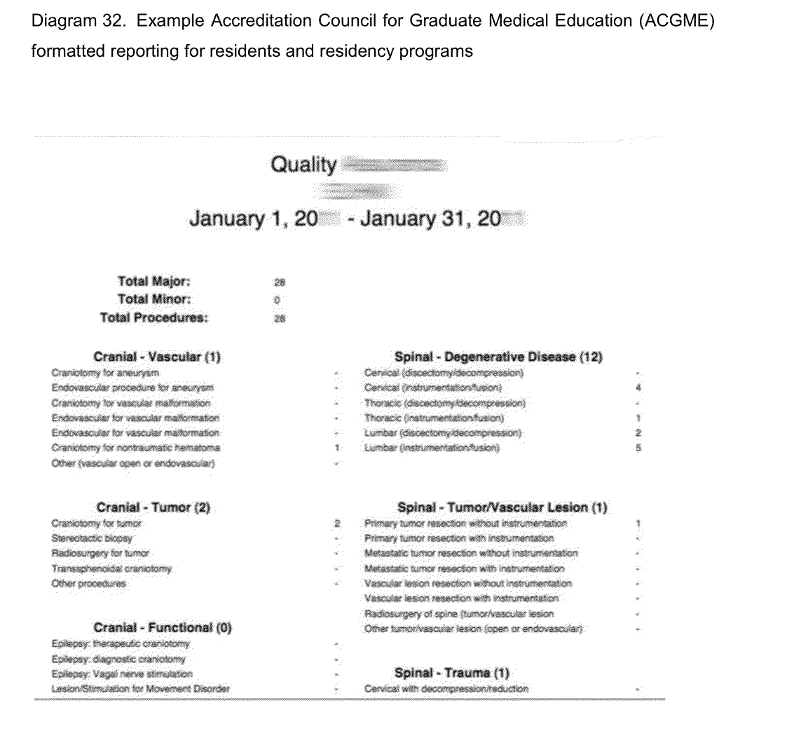

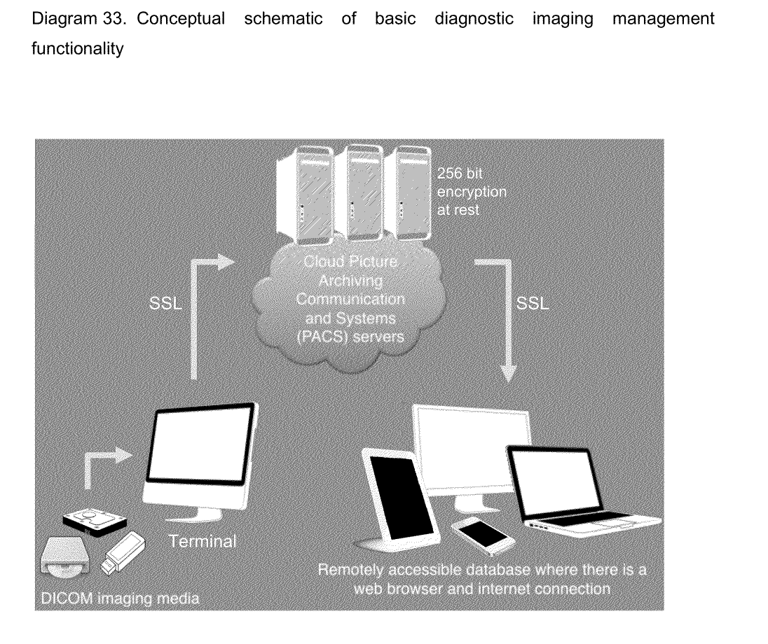

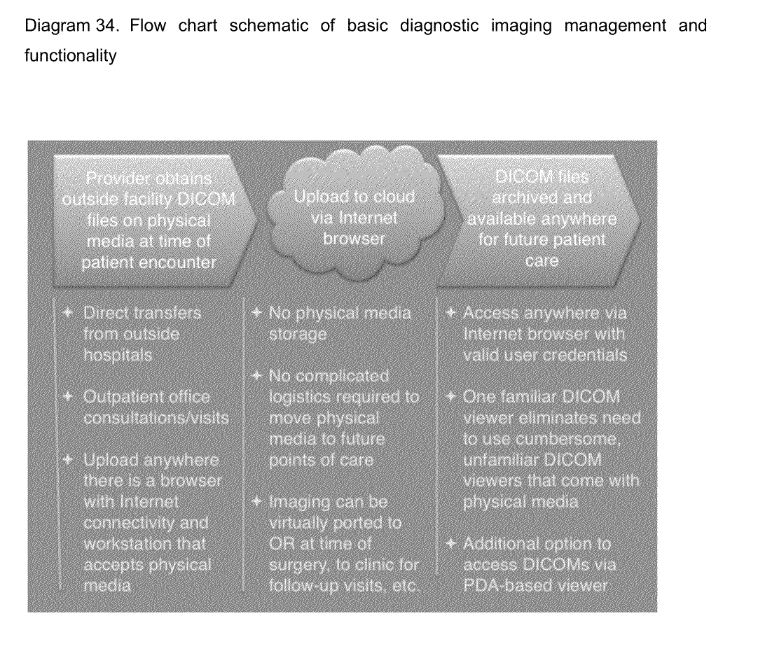

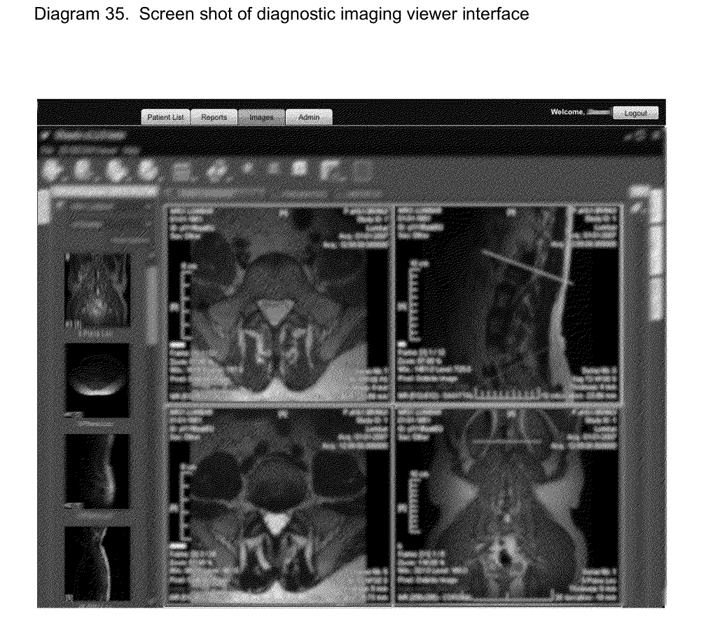

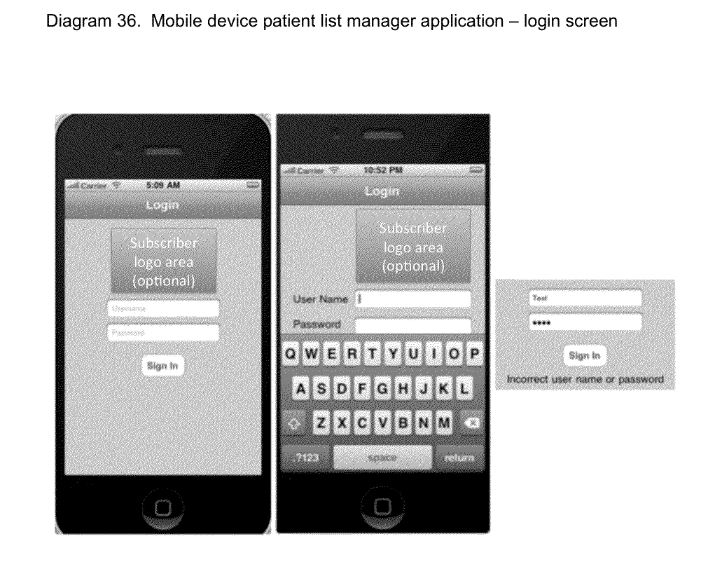

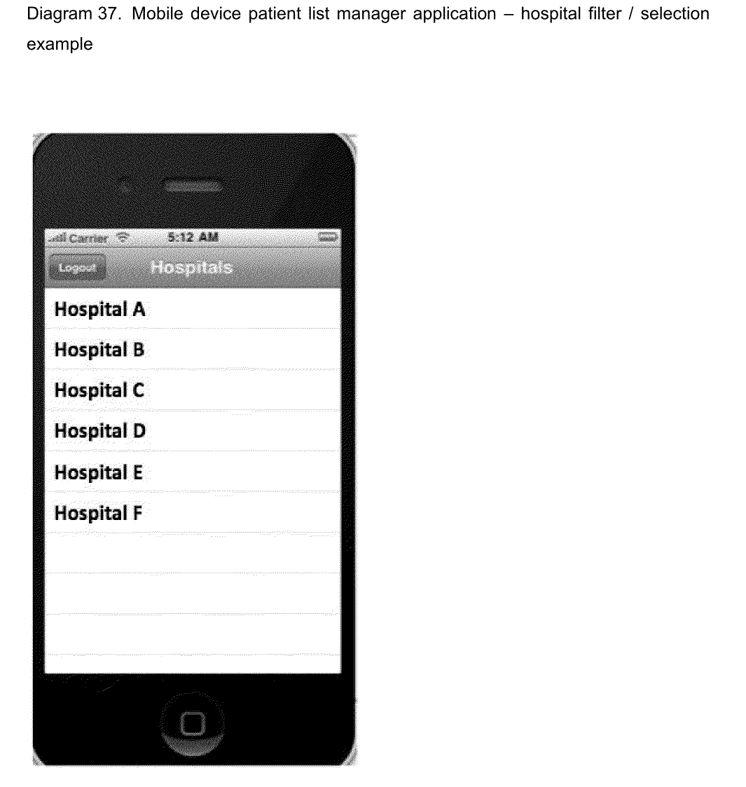

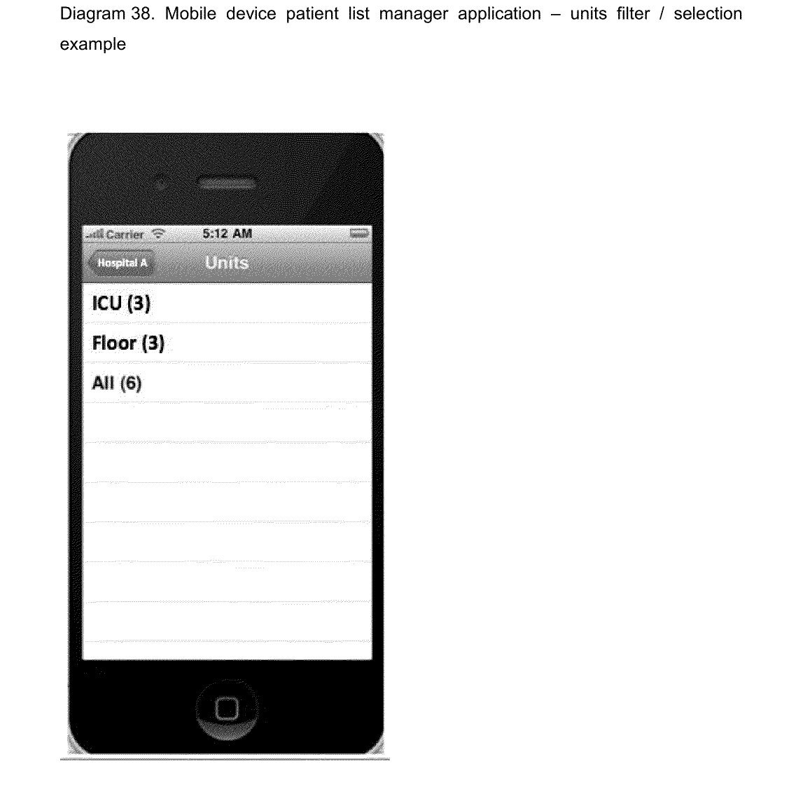

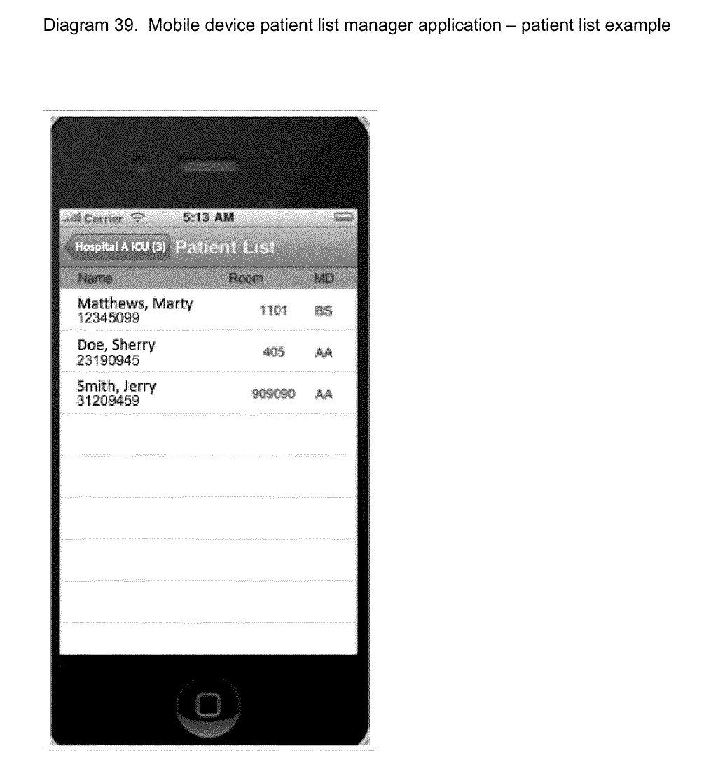

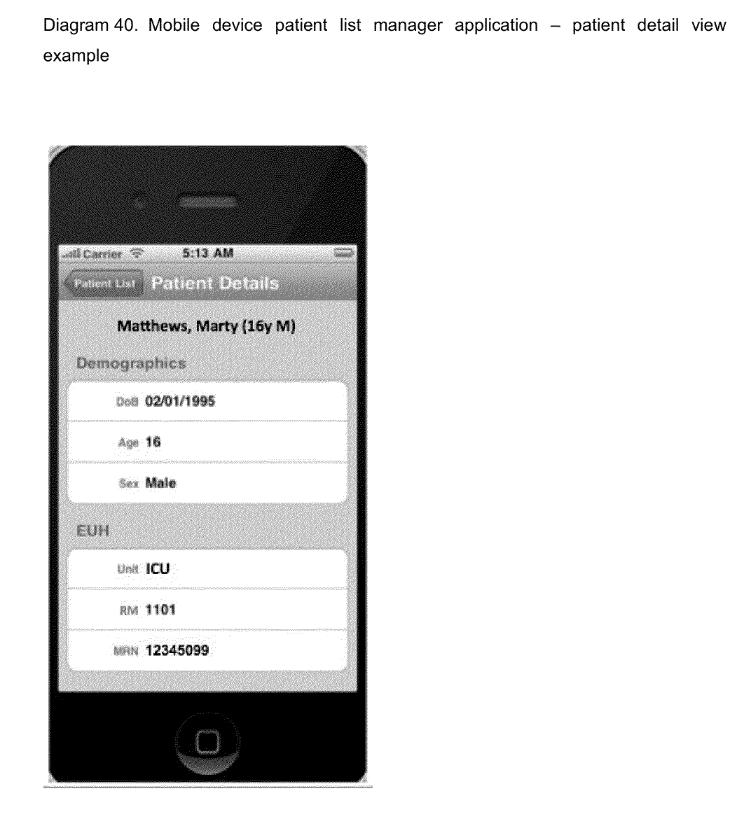

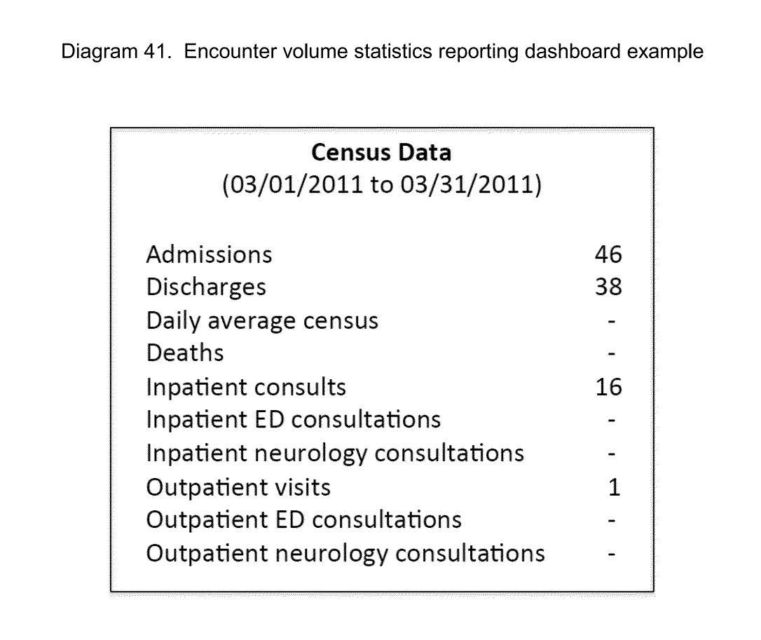

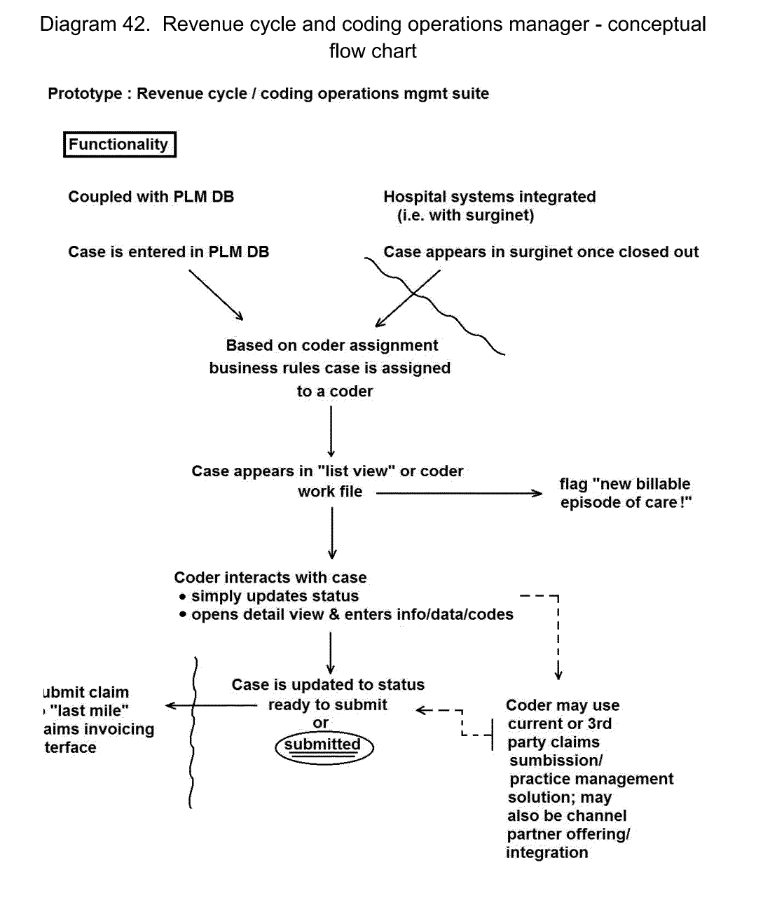

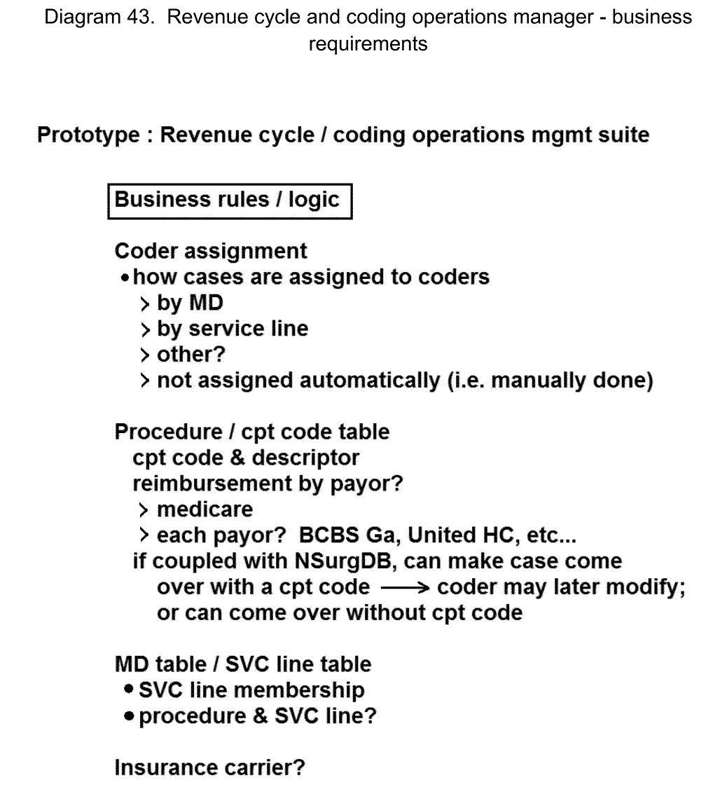

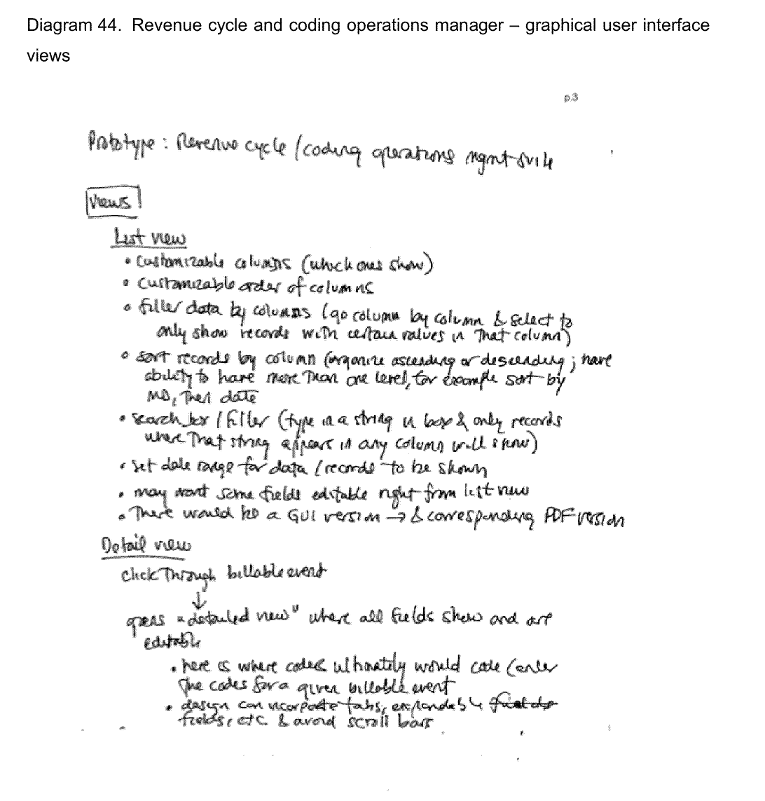

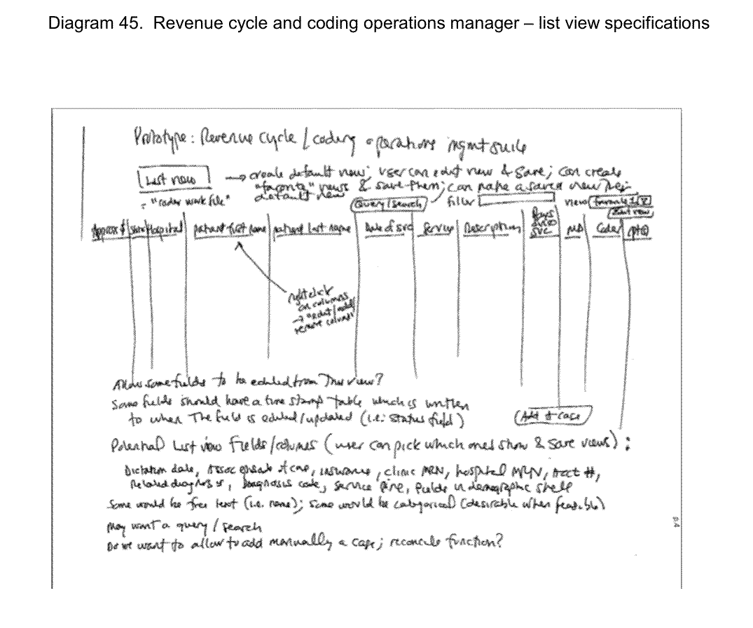

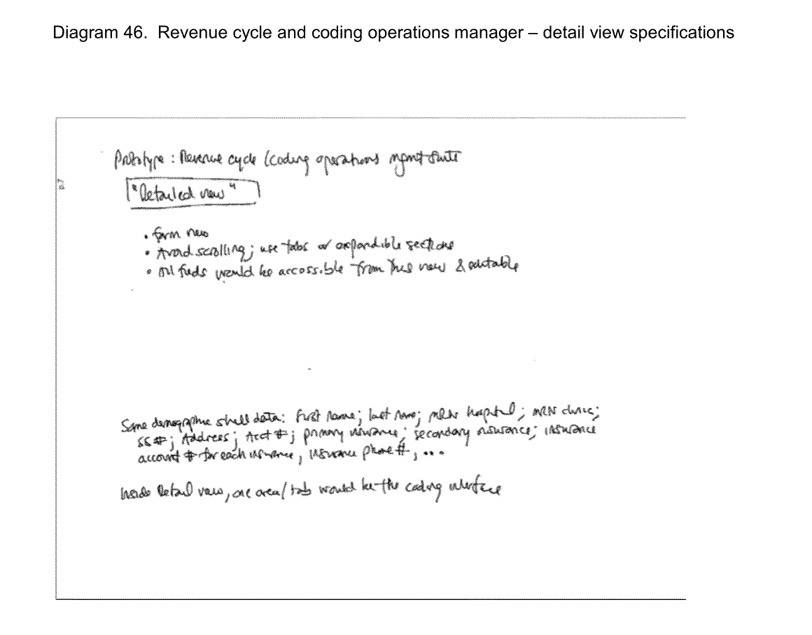

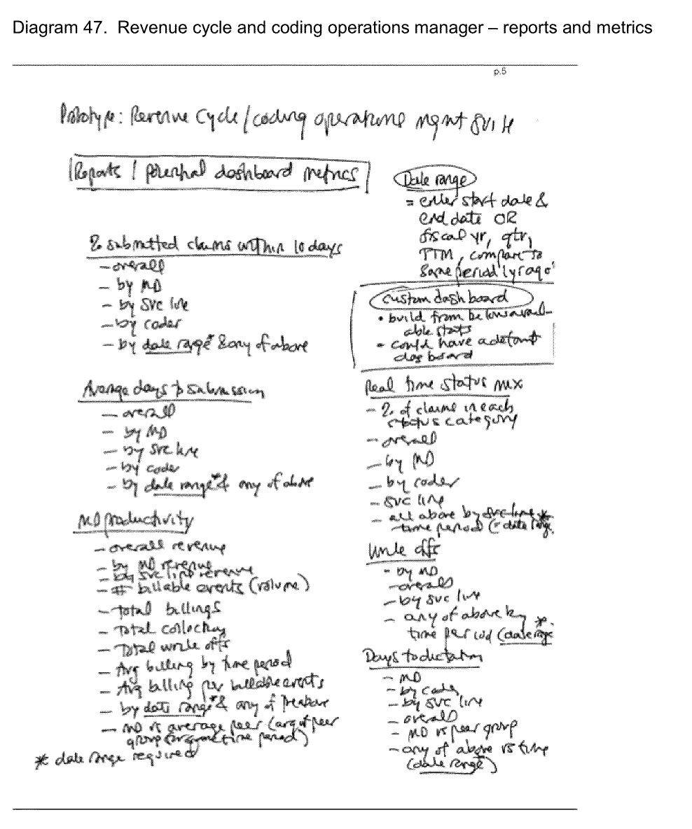

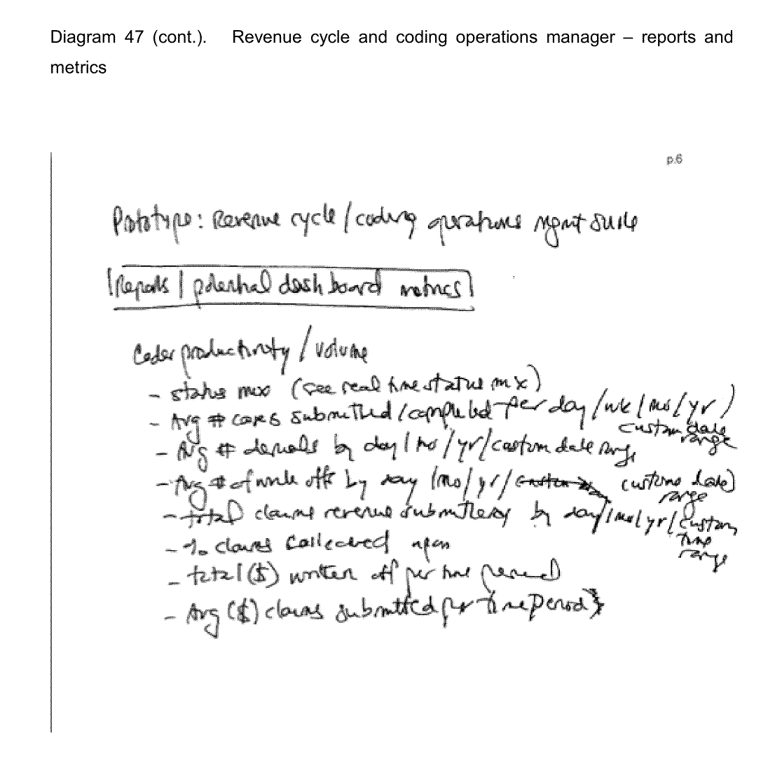

### STATEMENT OF RELATED APPLICATIONS

This application is a non-provisional of and claims the benefit of U.S. Provisional Patent Application No. 61/579,956 having a filing date of 23 Dec. 2011.

### BACKGROUND OF THE INVENTION

1. Technical Field

The present application generally relates to medical data and images and more specifically to the acquisition of this information across multiple points of care or other locations to a centralized repository and subsequent viewing of the detailed data and summary reporting thereof in near real-time using web enabled technologies and various clients.

2. Prior Art
U.S. Pat. No. 7,353,238 for an Apparatus and methods for determining and processing medical outcomes, Richard E. Gliklich, Boston, Mass.
US Patent Publication No. US 2011/0153351 A for a Collaborative medical imaging web application, Gregory Vesper et al
US Patent Publication No. US 2011/0110568 A1 for a Web enabled medical image repository, Gregory Vesper et al

### BRIEF DESCRIPTION OF THE DRAWINGS

Diagram 1. Cross facility data management need—schematic/caricature. Drawing depicting concept of physician centric (rather than facility centric) data capture across disparate unaffiliated facilities on potentially different and un-integrated healthcare information systems.

Diagram 2. System design schematic. Drawing depicting a cloud-based solution offering that is accessible via any client (stationary or mobile computer or mobile device) with a web-browser and an Internet connection or potentially via an application installed on a mobile device providing a richer user experience.

Diagram 3. Patient list manager—modular design. Drawing depicting the patient list manager as the base or central solution offering onto which bolt-on or plug-in modules and sub-modules can be added in order to create additional value for the installed user base of the patient list manager.

Diagram 4. Patient list manager—login screen. Screen shot of the login screen for the secure cloud based solution offering shown in a typical web-browser.

Diagram 5. Patient list manager—home. Screen shot of the patient list manager home, the current encounter patient list, which can be filtered to show the set of patients of interest to the individual that has logged in.

Diagram 6. Patient list manager—pull down filters and open text filter field. Screen shot showing close up of patient list manager current encounter filters which the user uses to show only the patients of interest at any given time.

Diagram 7. Patient list manager—hospital filter selection. Screen shot showing close up of patient list manager current encounter hospital filter pull down menu which the user uses to show only the patients of interest on the patient list at any given time.

Diagram 8. Patient list manager—physician or physician group filter selection. Screen shot showing close up of patient list manager current encounter physician/physician group filter pull down menu which the user uses to show only the patients of interest on the patient list at any given time.

Diagram 9. Patient list manager—add patient button highlighted. Screen shot with ‘add’ [patient] button in patient list manager highlighted; pressing this button is first step user takes to add a patient to a patient list.

Diagram 10. Patient list manager—add (or edit) patient screen. Screen shot of add patient screen user is taken to after pressing ‘add’ patient button from the patient list within the patient list manager; here user captures data about a patient, the care episode details, and diagnosis and procedure information.

Diagram 11. Patient list manager—add (or edit) patient screen: selection of encounter type. Screen shot of the categorical encounter type pull down menu user interacts with to capture the encounter type for a care episode at the time a patient is added in the patient list manager.

Diagram 12. Patient list manager—add (or edit) patient screen: selection of diagnosis type. Screen shot of the categorical diagnosis type pull down menu user interacts with to capture the diagnoses for a care episode at the time a patient is added in the patient list manager.

Diagram 13. Patient list manager—add (or edit) patient screen: entering procedure type and other procedure data. Screen shot of add procedure functionality in the patient list manager; in this area, user captures details of procedures done in association with a particular clinical encounter.

Diagram 14. Patient list manager—portable document format (PDF) patient list generation button highlighted. Screen shot with ‘Print PDF’ button in patient list manager highlighted; pressing this button generates a PDF patient list using the same filter settings the user selected in the graphical user interface. User can use this list to drive sign-out report and to take notes; a list hard copy can be carried for quick reference.

Diagram 15. Patient list manager—PDF current encounter patient list/sign-out report example. Example of a PDF patient list generated by the patient list manager; PDF is created using the same filter settings the user selected in the graphical user interface. User can use this list to drive sign-out report at the time of care team transitions and to take notes; a list hard copy can be carried for quick reference.

Diagram 16. Patient list manager—remove patient button highlighted. Screen shot with ‘Remove’ [patient] button in patient list manager highlighted. To remove a patient encounter from ‘current’ status, for example, at the time a patient is discharged from the hospital or sent home from the office or clinic, the user highlights the row of the patient to be removed from the list of current encounters and presses this highlighted button.

Diagram 17. Patient list manager—remove patient screen. Screen shot of destination user is taken to upon pressing the remove patient screen after highlighting a particular patient to be removed from the list of current encounters. The user can select the disposition category for the patient; for example, if the patient was discharged from the inpatient setting to a skilled nursing facility.

Diagram 18. Patient list manager—remove patient screen: select disposition type. Screen shot showing disposition type pull down with categorical options user can choose among. Categories available in the pull down list are set by the administrator in the administrative panel.

Diagram 19. Patient list manager—remove patient screen: flag morbidities. Screen shot showing functionality that enables a user to tag a particular care episode as a morbidity and provide additional detail. This is a use case sometimes desirable in academic medical centers where part of the clinical training of residents involves review of morbidities and mortalities that have occurred; this functionality allows these to be flagged and annotated for future reference.
Diagram 20. Patient list manager—admin panel: audit log. Screen shot showing administrative panel audit log functionality and viewing interface.

Diagram 21. Patient list manager—admin panel: diagnosis manager. Screen shot showing administrative panel area where diagnosis pull down list in the patient list manager is edited, modified, or customized.

Diagram 22. Patient list manager—admin panel: disposition type manager. Screen shot showing administrative panel area where disposition type pull down list in the patient list manager is edited, modified, or customized.

Diagram 23. Patient list manager—admin panel: encounter type manager. Screen shot showing administrative panel area where encounter type pull down list in the patient list manager is edited, modified, or customized.

Diagram 24. Patient list manager—admin panel: facility name manager. Screen shot showing administrative panel area where facility name (i.e. hospital) pull down list in the patient list manager is edited, modified, or customized.

Diagram 25. Patient list manager—admin panel: inter-practice physician group manager. Screen shot showing administrative panel area where physician grouping functionality (filter setting allowing patient list to be filtered by a subspecialty group, for example, within a larger physician group practice) is managed, edited, modified, and customized.

Diagram 26. Patient list manager—admin panel: procedure manager. Screen shot showing administrative panel area where procedure pull down list in the patient list manager is edited, modified, or customized.

Diagram 27. Patient list manager—admin panel: unit type/name manager. Screen shot showing administrative panel area where the unit type/name pull down list (which drives patient list grouping in the graphical user interface and permits patient list to fit within rounding workflow of physician end users) in the patient list manager is edited, modified, or customized.

Diagram 28. Patient list manager—admin panel: user manager. Screen shot showing administrative panel area where the system user access and new user account creation and validation is managed by the local site/practice administrator.

Diagram 29. Basic query engine interface with customizable criteria. Screen shot showing a simple implementation of a query engine interface allowing appropriately credentialed and authorized users to query historical clinical encounters for business or clinical intelligence purposes.

Diagram 30. Report builder module interface example showing morbidity and mortality report generation interface. Screen shot showing a simple report builder interface example; here user can select facility and date range over which to generate a morbidity and mortality report for resident education purposes. Various other turnkey reports are made available to the user in this same interface (note some other report options shown on the left panel of the screen shot).

Diagram 31. Resident case log report schematic. Screen shot showing an example of a potential turnkey PDF resident physician operative experience report format that could be generated using the patient list manager surgical case log manager module.

Diagram 32. Example Accreditation Council for Graduate Medical Education (ACGME) formatted reporting for residents and residency programs. Screen shot showing an example of a potential turnkey PDF ACGME style residency training program clinical and operative volume statistics report (by encounter and procedure type) that could be generated using the patient list manager residency accreditation compliance reporting module.

Diagram 33. Conceptual schematic of basic diagnostic imaging management functionality. Schematic showing process by which physical diagnostic imaging media is uploaded to the cloud from any point of care or other location and then accessed securely via the diagnostic imaging viewer in the patient list manager diagnostic imaging management module.

Diagram 34. Flow chart schematic of basic diagnostic imaging management and functionality. Flow chart schematic describing process and benefits of using the patient list manager diagnostic imaging management module as a substitute for traditional manual management of physical diagnostic imaging media.

Diagram 35. Screen shot of diagnostic imaging viewer interface. Screen shot showing one implementation of an integrated diagnostic imaging viewer utilizing the patient list manager diagnostic imaging management module.

Diagram 36. Mobile device patient list manager application—login screen. Screen shot showing login screen to the patient list manager via a native mobile device application (iPhone implementation shown here), a client that securely accesses the cloud based patient list manager backend database providing a richer user experience on a mobile device.

Diagram 37. Mobile device patient list manager application—hospital filter/selection example. Screen shot showing step user can take to filter patient list by hospital in a native mobile device application (iPhone implementation shown here), a client that securely accesses the cloud based patient list manager backend.

Diagram 38. Mobile device patient list manager application—units filter/selection example. Screen shot showing step user can take to filter patient list by hospital unit in a native mobile device application (iPhone implementation shown here), a client that securely accesses the cloud based patient list manager backend.

Diagram 39. Mobile device patient list manager application—patient list example. Screen shot showing user interface view of a patient list in the patient list manager solution accessed via a native mobile device application (iPhone implementation shown here), a client that securely communicates with the cloud based patient list manager backend.

Diagram 40. Mobile device patient list manager application—patient detail view example. Screen shot showing user interface view of a patient detail screen in the patient list manager solution accessed via a native mobile device application (iPhone implementation shown here), a client that securely communicates with the cloud based patient list manager backend.

Diagram 41. Encounter volume statistics reporting dashboard example. Screen shot showing an example dashboard view of clinical encounter volume statistics.

Diagram 42. Revenue cycle and coding operations manager—conceptual flow chart. Flow chart schematic communicating functionality and process workflow for revenue cycle and coding operations management module.

Diagram 43. Revenue cycle and coding operations manager—business requirements. List of some of the business requirements for some of the functionality in the revenue cycle and coding operations management module.

Diagram 44. Revenue cycle and coding operations manager—graphical user interface views. List of a few of the graphical user interface views and corresponding functionality in the revenue cycle coding and operations management module.

Diagram 45. Revenue cycle and coding operations manager—list view specifications. Conceptual sketch of graphical user interface list view in the revenue cycle and coding operations management module.

Diagram 46. Revenue cycle and coding operations manager—detail view specifications. Additional features and functionality information for the revenue cycle coding and operations management module billable episode of care detail view in the graphical user interface.

Diagram 47. Revenue cycle and coding operations manager—reports and metrics. Listing of several statistics, metrics, etc. and potential groupings of these into reports for the dashboards driven by data captured in the patient list manager and accessed via the revenue cycle and coding operations management module.

### DETAILED DESCRIPTION OF PREFERRED EMBODIMENTS

Cross-Facility Patient List Manager—Base Offering

The cross-facility patient list manager is a solution that creates value for physicians and other providers that provide services across multiple often times un-affiliated facilities (from a facility ownership perspective) in addition to possibly seeing patients in their offices (Diagram 1). Physicians and providers who provide their services in this fashion are faced with challenges that result from data siloed at the facility level. Information about the care episodes rendered is captured at the facility level; however, physicians and other providers often need quick access to some of this information in various instances in order to best care for their patients. This information, however, is not readily available in one interface. The physicians and other providers have to instead access the records physically (for those facilities on paper based records), electronically (if the facilities at which they are providing services are on electronic medical records, for example), or they use manual work arounds (i.e. write information on paper or paper forms) to capture a subset of the data maintained at the facility level for easy access (the portion they need and deem most important to have and readily be able to reference). This problem is exacerbated by the fact that this subset of physicians sees patients across multiple facilities (Diagram 1) with different data capture and clinical information/documentation solutions (paper, electronic medical record systems, etc.) and, thus, accessing the information they need from each facility is a distinct process at each facility; even those facilities on electronic medical records have systems that do not communicate with similar systems at unaffiliated facilities and often the IT system in the physician or other providers outpatient office. Moreover, remote access to the information systems at multiple unaffiliated facilities via one interface is not commonplace in the current prevailing paradigm.

The cross facility patient list manager (Diagram 1, Diagram 5, Diagrams 37-40) helps address the issues resulting from gaps in cross-facility data access and the current inability of physicians and other providers to visualize cross-facility data in one interface from the physician or other providers prospective. Physicians and other providers, or groups of such individuals, use the patient list manager, a web-based, cloud hosted, point of care solution accessible via any web-enabled device with an Internet connection (Diagram 2, Diagram 4, Diagram 36). At each point of care in which the physician or other provider renders services, they login to the patient list manager via a client device and abstract and capture structured data about each care episode via the client device (Diagrams 9-13). They or other authorized members of their practice can then access the information captured in near real time anytime, anywhere and utilize it to better care for their patients and improve the efficiency of their practice's operations.

Data captured includes, but is not limited to, patient demographics, categorical diagnose(s), dates of service, treating physician(s), surgical procedures, operating surgeon(s) and assistant(s), and location of care episodes (facility, unit, and room number), among other information (Diagram 10). Data is stored encrypted, is encrypted in motion, and is accessible in the graphical user interface only with valid credentials (authentication via password). Data is populated into the system by the physician or other provider at any point of care or other location; the provider logs in with appropriate credentials via any web browser on any device or via a mobile device specific application (Diagram 2, Diagram 4, Diagram 36) and can then populate or abstract data into the system (Diagram 10) about patients they see and those they are actively managing (Diagram 5). Current encounters retain this status and are seen upon login (Diagram 5). The view can be filtered with a free text filter field or based on several criteria, including but not limited to provider, location of service, subspecialty group, among others (Diagrams 6-8, Diagrams 37-38). When an encounter episode ends, the user updates the status and can categorize the disposition type; for example, a patient discharged from the hospital (Diagrams 16-18)). In addition, care episodes can be flagged for future reference in the event some morbidity occurred and the provider wishes to be able to identify this subset of patients readily; free text notes can be captured about the care episode if flagged (Diagram 19). Patient episodes of care are captured in a structured fashion leveraging pull downs populated by look up tables. Limited free text is permitted for convenience to allow the provider to add custom notes of relevance (beyond that captured by the structured categorical designations), for example, diagnosis and procedure details (Diagrams 12-13) and to have this information displayed on the patient list (Diagram 5, Diagram 15). The list of current encounters can be viewed in the graphical user interface; or alternatively, a PDF can be generated (Diagrams 14-15) to view the information in order to provide consistent formatting should the user desire to print a ‘hard copy.’ An administrative panel is available to users with appropriate credentials enabling the management of users, and the data populating the facility, unit, diagnosis, procedure, and disposition tables, among other functionality (Diagrams 21-28). An audit log is also implemented to track activities of all users (Diagram 20).

The patient list manager is a base offering (Diagram 3) for the solution's subscriber base. Several additional modules and sub-modules, (Diagram 3) which create additional value for the end users are available and carry out additional functionality. The functionality of several of these modules is described herein. Subscribers have the flexibility to subscribe to only those modules that carry out functionality they need.

Mobile device specific cross-facility patient list manager application

The patient list manager solution can be accessed via any web enabled mobile device (i.e. cellular phone, tablet computer, etc.); however, mobile device specific applications (i.e. for the iPhone) can provide a richer user experience (Diagrams 36-40) on specific device clients. Such applications make a large majority of the functionality available in the web-based offering accessible via a local secure mobile device application that communicates with the patient list manager server backend on the cloud. Viewing the patient list and filtering the list by user specified criteria and adding new patient care episodes at the point of care are among the functions that can be carried out via a device specific mobile application (Diagrams 37-40).

Sign-Out Report Manager—Module

Sign-out is a critical interaction for the transfer of key patient information between care teams at shift changes for physicians and other providers. In the wake of the Institute of Medicine's 2000 Report, To Err Is Human, and the resultant resident duty hours restrictions and focus on fatigue related medical errors, medical and surgical practice in many care settings has moved towards more of a “shift-work” paradigm. As such, more and more attention is now being focused on ensuring safe transitions in patient care and the most effective means of communicating important details about each patient between providers at shift change. Providers are increasingly finding themselves in the role of caring for patients for whom they are not the primary provider (“cross-covering” for their colleague's and their partner's patients); thus, they potentially lack intimate familiarity with each patient's situation, magnifying the importance of effective communication during handoffs in patient care.

Sign-out is yet another opportunity to introduce misinformation or to fail to effectively communicate vital information; thus, the more standardized these transitions in patient care teams can be made, the more likely patient care teams are to avoid inadvertent lapses in communication that can lead to medical errors. The sign-out report manager is a tool that integrates into the patient list manager and helps physicians and other providers better execute and standardize their sign-out communications. There are a few key items that must be communicated during sign-out; a partial listing of these includes (but is not limited to):
Patient condition and code status
Current diagnoses and recent procedures
Current significant medical and surgical issues
Items requiring provider action during the next shift
Patient care interventions that need to be ordered or completed
Tests and diagnostic results that need follow-up
High-level plan of care and related action items

The sign-out report manager provides a structured way for physicians and other providers to capture and share data facilitating smooth and effective transitions in patient care during care team handoffs. A sign-out report patient list with pertinent information previously abstracted and captured in the patient list manager system by a physician or other provider (i.e. data previously entered at the point of care) is viewed via a web browser (Diagram 5), via another client (i.e. a mobile device), or alternatively via a patient list sign-out report ‘hard copy’ printed out from the system (Diagram 15). The data populating the fields on the sign-out report patient list is used to help guide the physicians or other providers as they review the pertinent details about each patient during care team transitions (i.e. shift change). The patient list sign-out report aids the physicians or other providers with conducting their sign-outs and communicating the plan of care in a structured, standardized, and methodical fashion driven by the aid of a visual report populated with near real time cross-facility data.

Diagnostic Imaging Manager—Module

Like medical records logistics, logistics for managing diagnostic imaging media can also be challenging for physicians and other providers, particularly those who need to access imaging and view it first hand rather than relying on the written or verbal interpretation of a radiologist; surgeons are one such group. In addition, the availability of the diagnostic imaging at multiple points of care (i.e. in the office, in the operating room, in the emergency room, etc.) is highly desirable from a quality of care and cost of care perspective, yet fraught with logistical challenges and additional expense (delivery of the physical media to the point of care in coordination with appointment times, dates of surgery, etc.).

The information technology solutions for managing diagnostic imaging have evolved around radiologists and their workflow (i.e. the need to know an imaging study was completed such that they can interpret the films and generate a formal dictation on the images to be routed to the referring physician). Despite these advances, patients are often cared for by physicians and other providers that are unaffiliated with the imaging center where the diagnostic imaging was obtained or interpreted by a radiologist. In fact, in many cases, the physician or provider that orders a diagnostic imaging study may themselves be unaffiliated with the imaging center and work in a location physically different from (and under separate ownership than) the imaging center; moreover, this individual might, in the event it is indicated, then send the patient that underwent the diagnostic imaging study to be seen by a specialist in yet another separate physical location. Networks for the transport of diagnostic imaging are emerging, but are still in their infancy. In the large majority of cases, imaging is carried between physicians and other providers physically on actual physical media (i.e. on compact disc read-only memory). This can result in several inefficiencies (i.e. patient forgets imaging on day of appointment or surgery, provider forgets or loses imaging, etc.) and unnecessary expense (i.e. imaging is repeated because it is not available).

In instances when diagnostic imaging studies are successfully delivered on physical media to a point of care, there are also challenges with viewing the images. The file formats are often a specialized type that requires specific viewing software not widely available on most computers. For this reason, the images on the physical media are typically packaged with an imaging viewer software. However, there is a highly fragmented market of software vendors that provide these viewers and with significant frequency the physicians or other providers are unfamiliar with the nuances of operating the specific vendor's software and, as a result, viewing the films becomes a time sink, injecting further inefficiencies into an already complicated process. This can be disruptive patient flow bottleneck in a busy clinic. Moreover, some of the imaging viewer software requires local installation and administrative rights to the operating system on the local computer, which is not something the physicians or other providers have in some care settings.

The diagnostic imaging manager module's functionality includes the ability to i) securely upload encrypted imaging files from physical media at any point of care, including images formatted with the DICOM (Digital Imaging and Communications in Medicine) standard, to the cloud; ii) store the images uploaded and the imaging header information on the cloud in an encrypted fashion; and iii) index the images uploaded and tag them to the corresponding patients in the patient list manager system (Diagrams 33-34). Another major component of this module is an imaging viewer that can render the images uploaded in the graphical user interface (Diagram 35). This allows providers using the system to access, view, and manipulate images that are uploaded (traverse sections, zoom, window, etc.) at any point of care (or other location where they have a device that has Internet connectivity) at anytime as long as they have the appropriate credentials, thereby eliminating the pain of interacting with a potentially unfamiliar diagnostic imaging viewer that accompanies the files on the physical media on which they come.

Surgical Case Log Manager—Module

For years surgeons have kept manual surgical case logs which effectively served as paper based “databases” of the surgeries they have completed historically. All surgeons and anyone who has rotated on a surgical service is all too familiar with these composition books and ledgers with patient stickers and hand written notes about each surgery done and which physicians or other providers participated in the case. These physician or provider centric surgical case logs are not typically maintained as a part of the official legal facility or hospital based medical records (i.e. in the medical records system), but instead are, in many cases, manually maintained by the physician or other provider. The surgical case logs serve as a historical record or database of the surgical cases each individual physician or other provider participated in previously (as far back as they have maintained records) up to the current time. The historical information is often needed for future reference, board certification, hospital credentialing, and to document the training of resident physicians as well as the experience provided by a particular residency training program.

Leveraging data captured at the point of care with the cross-facility patient list manager, surgeon case logs (Diagram 31) can be generated in a turnkey fashion. Case logs can also be generated for other providers that might participate in surgeries (i.e. physician assistants, nurse practitioners, etc.) as well as residents and medical students who frequently assist in surgeries that occur in academic medical centers. In fact, graduate medical education in the United States, particularly in surgical specialties, has become increasingly focused on having residency programs quantify the patient care experience of physicians during residency training with surgical case logs as this provides documentation of the breath and depth of each resident physician's operative experience.

Moreover, at the time surgeons complete residency training, in many specialties, each new attending surgeon then enters into a period called the surgical case “board collection period.” During this time period, these “board eligible” surgeons are required to i) gather information about the surgeries they ultimately complete during the first few years of their early careers and ii) submit this information to their specialty board as a part of the process of obtaining board certification in their surgical specialty. This creates a significant administrative burden as it typically requires manual data capture, it often involves re-keying duplicative data, and it frequently is accomplished by maintaining a paper based database for capturing this information. This tedious manual process is required simply because the data captured in the course of care provision resides in hospital and office paper records or information systems, neither of which are readily queryable directly by the surgeons for the purposes of complying with this required step in the board certification process.

Case log data is also something surgeons require when applying for privileges at any healthcare facility as a part of the credentialing process. Facilities have surgeons undergo this process in order to assess their competence and to determine whether they should grant a given physician privileges to i) admit patients; and ii) carry out invasive procedures within the facility. If a surgeon has not maintained the right information formatted correctly in his or her practice records historically, gathering this data can be painstaking and involve multiple phone calls and discussions with various gate keepers; the time required to reach the right personnel and the time it takes to get a report generated can be significant. In fact, in some cases, getting the necessary data can be impossible, particularly when access to healthcare information systems at a previous employer has ended. This issue is further exacerbated when a physician or other provider has been rendering their professional services at multiple unaffiliated facilities, as the process has to then be duplicated across facilities requiring interaction with a different set of gatekeepers at each facility.

In the surgical case log manager module, canned reports are made available to users (Diagram 31). A few examples of the reports that a user might generate include reports that sort or group procedures by various criteria, including, but not limited to, type, billing code, category, etc. Data can be reported in a de-identified fashion or with patient identifiers. Various criteria can be specified to drive report generation including, but not limited to, patient demographics, location of surgery, dates of surgery, provider, type of surgery, specific procedures, specific procedure codes, co-surgeons, assistants, etc. Volume reporting by case type, billing code, and category is also available. Canned reports populate a PDF, which can be printed (if a hard copy is desired) or viewed in the graphical user interface. Access to various reporting functionality is managed on a need to have basis; only users with a business or clinical need for certain reporting functions are given such access and the local administrator for the subscription manages this.

Clinical Encounter Case Log—Module

This module is similar to the surgical case log manager only it is focused on clinical episodes of care that are non-procedural (i.e. not patient surgeries) in nature. Individual physicians or other providers have a need for logs that capture their patient volumes, potentially across facilities, which can report care episodes individually or grouped by certain criteria for certain date ranges. This information is often needed for physician or other provider credentialing.

In the clinical encounter case log manager module, canned reports are made available to users. A few examples of the reports that a user might generate include reports that sort or group care episodes by various criteria, including, but not limited to, type (i.e. admission, inpatient consult, emergency room consult, etc.), billing code, diagnosis, etc. Data can be reported in a de-identified fashion or with patient identifiers. Various criteria can be specified to drive report generation including, but not limited to, patient demographics, location of care episode, dates of care episode, provider, diagnosis, care team members, etc. Canned reports populate a PDF, which can be printed (if a hard copy is desired) or viewed in the graphical user interface in the PDF format or as part of a dashboard (Diagram 41). Access to various reporting functionality is managed on a need to have basis; only users with a business or clinical need for certain reporting functions are given such access and the local administrator for the subscription manages this.

Clinical Encounters Dashboard Outcomes and Statistics Reporting—Module

Another module that users can subscribe to is one that reports, or displays in a dashboard, statistics about clinical encounters physicians or other providers have participated in across one or more potentially unaffiliated facilities; data statistics are updated automatically in the dashboard in real time (Diagram 41). The information is as up to date as the information last entered into the patient list manager. No manual data collection, manipulation or calculations are necessary which eliminates a significant amount of the cost and time lag generating this information typically entails. These metrics can be securely accessed and used by physician and other provider subscribers for business intelligence and clinical intelligence. The data helps these subscribers more efficiently manage their practices and to readily assess their activities across multiple facilities on disparate systems in one interface. Ultimately the data statistics and metrics reported can be used to improve patient outcomes and physician and other provider practice financial performance. Reports might include simple statistics for a subscriber specified date range such as clinical visit type volumes, surgical case types volumes and these respective volumes across facilities (Diagram 41), by individual facility, by provider, by service line, etc. More complicated statistics requiring mathematical or algorithmic operations on data captured that are determined to be important can also be generated and output to the dashboard such as wound infection rates, readmission rates, etc. Any statistics and metrics that can be generated leveraging the structured point of care data captured can be output and made visible to subscribers with appropriate credentials in the dashboard in real time. If historical reports with particular statistics and metrics covering certain time periods or comparing certain time periods are desired, these can be generated and viewed in the graphical user interface or populated into a PDF which can be printed if a hard copy is desired. The statistics and metrics help increase the visibility of work flows, outcomes and volumes enabling subscribers to objectively understand and better manage (in near real time) i) what is going on in their practice from a clinical and business operations standpoint, ii) practice and practice member productivity and performance versus targets; and iii) decision making around changes that might be made or implemented in the practice based on data driven impact assessment and key metric tracking and review.

Morbidity and Mortality Data Capture and Reporting—Module

Attending physicians, physicians in training, and other providers often have a desire or need to track information about patients they care for and any complications or deaths that might occur. The morbidity and mortality data capture and reporting module is an extension of the patient list manager offering that allows physicians to capture information about and flag care episodes where there has been some morbidity or mortality. One example of how this can be implemented is to allow the physician or other provider to capture this information at the point of care when a patient is transitioning care settings (Diagram 19). The information could also be captured at any other time during the continuum of care. Reports searching for patients flagged as morbidities or mortalities can then be run and used for quality improvement, outcomes assessment, and resident physician teaching in graduate medical education programs (Diagram 30).

Residency Program Accreditation Data Capture and Reporting—Module

Residency programs are required to capture clinical and surgical encounter and case volumes across multiple facilities for accreditation purposes. This data is frequently captured via manual data abstraction and capturing it can be quite time consuming and difficult to coordinate. The data collected manually can be highly variable in quality and is often inaccurate and incomplete. The data collection and the usefulness of the data are also frequently plagued by a significant time lag due to the tedious nature of duplicative manual data capture and entry. Some residency programs employ individuals with this manual data capture and entry as one of their job duties. Other residency programs require residents themselves to capture this data, often times manually, followed by rekeying of the data into third party systems. In the later scenario, the coordination piece of the data collection process is difficult and time consuming and often is carried out by an administrator in the residency program that polices the entry of clinical and surgical encounter data entry by the resident physicians. These issues and challenges are further exacerbated by the fact that resident physicians in many residency training programs go to multiple training sites or facilities that can be otherwise un-affiliated and on different medical records management systems which might be paper based or electronic.

The residency accreditation data capture and reporting module leverages the structured data captured at the point of care via the patient list manager to automate the residency program data capture and reporting for accreditation purposes eliminating several steps of painful data collection, data set merging, and data set analysis that is otherwise required. The residency program accreditation data capture and reporting module also eliminates the need to police the entry of case and encounter data into third party systems. Encounter and surgical case volume reports, even across disparate facilities, for residency program accreditation and re-accreditation purposes can be generated in the format required by the Accreditation Council for Graduate Medical Education (Diagram 32), the residency program accreditation entity in the United States, in a turnkey fashion. Canned reports can be populated into a PDF, which can be printed (if a hard copy is desired) or viewed in the graphical user interface. Individuals with appropriate credentials and user privileges can also download data for submission to the governing accreditation entities in electronic format. Within the system, the data can also be manipulated and output in other ways useful to the residency program for resident education (i.e. for evaluations to assess the experience a resident has had to date, to assess the clinical experience at various training sites, to guide faculty hiring needs, among many others).

Historical Encounter Query—Module

Clinical and business intelligence is a critical aspect of quality and operations improvement in medicine or for that matter any business. Without the ability to access data about historical activities, physicians, providers and business managers are left to operate their practices on subjective anecdotal evidence rather than objective measures and data. The historical encounter query module provides subscribers with appropriate credentials with access to a query engine that allows them to obtain information about prior care episodes for authorized purposes only. The query interface, which can be customized, allows users to search for current and historical patient encounters meeting various criteria (Diagram 29). The system leverages the structured data captured in each patient care episode within the patient list manager. Queries can be done with any number or combination of criteria and/or operators including but not limited to and, or, etc. Free text queries for one or more fields can also be carried out alone or in combination with structured element query fields. Criteria settings from any given query can be saved providing the ability to leverage time invested previously in entering desired query criteria for queries that may need to be run routinely. Results can be viewed in a list format (multiple patients) or individually in a patient detail view.

Coder Interface and Front End Revenue Cycle Management—Module

Coders, office personnel, and 3^{rd} party billing services that prepare claims for submission to payers for each billable episode of care a physician or other provider participates in often do not learn that billable care has been rendered until hours and often times several days after the care episode occurs. This potentially impacts physician and other providers adversely from a financial perspective by increasing the working capital tied up in their business via lengthening the time payables remain in their accounts receivable. The problem is further exacerbated when physicians and other providers see and treat patients in multiple potentially otherwise un-affiliated facilities separate from their home offices (i.e. inpatient hospital facilities) as there is no standard way for information about the care episodes physicians or other providers participate in to be transmitted back to their office for the billing of the professional services rendered. Currently, in many physician or other provider practices, manual processes and home grown solutions are used to fill this void or gap in communications and often consist of a patchwork of email, facsimile, or paper based correspondence (forms or cards brought to the point of care and carried by a physician or other provider back to those in their offices that do the billing for their services or to the 3^{rd} party service providers they contract with for these services). Many of these manual home grown processes not only have a financial cost to the practice but also potentially are not in compliance with the patient privacy and data security regulations delineated in the Health Information Portability and Accountability Act of 1996, known as HIPAA.

The coder interface and front end revenue cycle management module (Diagram 42-47) leverages structured data captured (via the patient list manager) about care episodes physicians and other providers engage in across multiple facilities to securely notify (in a HIPAA compliant fashion) office personnel (i.e. coders, billing managers, etc.) when a billable episode of care has occurred (Diagram 42, Diagram 45). With this information, the billers and coders can then move forward with the steps entailed in invoicing payors for each episode of care such as obtaining the documentation of the care episode, gathering the other data elements required for billing, and invoicing patients and third party payors (submitting claims) for each billable episode of care. The data captured in the patient list manager provides a significant subset of the data needed by the coding and billing personnel for the claims submission process, which they can verify and then use to start to build the claim increasing the efficiency of their work. Moreover, the status of any given claim and the time it takes to be submitted into the practice management or claims submission solution used in the physician's or other provider's office can be tracked to increase the visibility of the practice's claims processing work flow potentially allowing for the reporting of additional statistics and metrics (Diagram 47) which can help further improve the efficiency of the practice's operations.

What is claimed is:

1. A secure cross-facility web-based patient list manager system hosted centrally in a cloud based data center accessible by a web enabled device or a mobile device based application client by authorized medical providers.

2. The system as claimed in claim 1, further comprising integrated physician and other provider surgical case logs.

3. The system as claimed in claim 1, further comprising integrated physician and other provider clinical encounter logs.

4. The system as claimed in claim 1, further comprising integrated secure web based diagnostic imaging uploading, tagging, cataloging, and viewing.

5. The system as claimed in claim 1, further comprising an integrated sign-out report manager for transitions in patient care teams.

6. The system as claimed in claim 1, further comprising integrated morbidity and mortality data capture, querying, and reporting.

7. The system as claimed in claim 1, further comprising an integrated historical encounter query engine.

8. The system as claimed in claim 1, further comprising integrated clinical encounter volumes, outcomes and statistics dashboards and reporting.

9. The system as claimed in claim 1, further comprising integrated residency program accreditation data capture, querying, and reporting.

10. The system as claimed in claim 1, further comprising an integrated revenue cycle and coding operations management suite.

11. The system as claimed in claim 1, wherein the system is physician-centric.

12. A method for operating A secure cross-facility web-based patient list manager system hosted centrally in a cloud based data center accessible by a web enabled device or a mobile device based application client by authorized medical providers.
